(19) United States
(12) Patent Application Publication
(10) Pub. No.: US 2016/0371981 A1
(43) Pub. Date: Dec. 22, 2016

(54) Portable Blind Spot Detector

(71) Applicant: Suwito Suryaerlangga, Rosemead, CA (US)

(72) Inventor: Suwito Suryaerlangga, Rosemead, CA (US)

(21) Appl. No.: 15/189,099

(22) Filed: Jun. 22, 2016

Related U.S. Application Data
(60) Provisional application No. 62/182,834, filed on Jun. 22, 2015.

(51) Int. Cl. G08G 1/16; B60Q 9/00; B60R 11/00

(52) U.S. Cl. CPC G08G 1/167; B60R 11/00; B60Q 9/008; B60R 2011/0057

(57) ABSTRACT

A portable blind spot detector. The present system comprises a housing having walls that define an interior, the housing having fasteners that are configured to removably secure the housing to the exterior of a vehicle. A sensor is disposed within the interior and is operably connected to a wireless transmitter, a logic, and a power source. The sensor is configured to relay a signal to an alerting unit when a vehicle is detected entering within a predetermined distance from the sensor. In some embodiments of the portable blind spot detector, the alerting unit is a mobile phone. In further embodiments of the portable blind spot detector, the fasteners are magnetic elements disposed on the walls of the housing.

### CROSS REFERENCE TO RELATED APPLICATIONS

This application claims the benefit of U.S. Provisional Application No. 62/182,834 filed on Jun. 22, 2015. The above identified patent application is herein incorporated by reference in its entirety to provide continuity of disclosure.

### BACKGROUND OF THE INVENTION

The present invention relates to blind spot detectors. More specifically, the present invention relates to portable blind spot detectors that are removably securable to a vehicle exterior.

Being alert and aware of the immediate surroundings while driving a vehicle is among the most significant safety precautions a driver of a vehicle can take. While mirrors are indispensable tools in affording drivers visual cues both to the rear and to the sides of their vehicle, there are often areas that cannot be seen through the mirrors, commonly referred to as blind spots. In some vehicles, such as smaller passenger cars, a driver can physically turn their head to view at most of the blind spots. However, the field of vision of larger vehicles, such as trucks and tractor trailers, is often very limited even when a driver turns their head, as the size of the vehicle and location of the driver seat can limit their potential to see blind spots.

In addressing the drawbacks related to blind spots, many vehicles employ detectors that are configured to alert a driver when a vehicle has entered the blind spot areas. Some blind spot detector systems are incorporated within the existent electronic system of the vehicle and sound an alarm or illuminate an indication light to alert the driver that a vehicle has been detected. Other systems taught in the prior art convey a signal from the integrated sensor to a mobile device, allowing the audio or visual alert to be transmitted and personalized through a mobile phone. However, these systems are not portable and lack the ability to be easily transferred from one vehicle to another. This can be a particularly significant drawback for truck drivers or others who may drive multiple vehicles often and wish to use the same system on all vehicles. Additionally, some vehicles lack the built electronics to allow for an integrated warning system, making it very costly to install one.

### SUMMARY OF THE INVENTION

In view of the foregoing disadvantages inherent in the known types of blind spot detectors now present in the prior art, the present invention provides a blind spot detector wherein the same can be utilized for providing convenience for a driver wishing to be altered of vehicles entering a blind spot. The present system comprises a housing having walls that define an interior, the housing having fasteners that are configured to be removably secured to the exterior of a vehicle. A sensor is disposed within the interior and is operably connected to a wireless transmitter, a logic, and a power source. The sensor is configured to relay a signal to an alerting unit when an object, such as an adjacent vehicle on a roadway, is detected to come within a predetermined distance from the sensor. In some embodiments of the portable blind spot detector, the alerting unit is a mobile phone. In further embodiments of the portable blind spot detector, the fasteners are magnetic elements disposed on the walls of the housing.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective cutaway view of the housing of the portable blind spot detector.

FIG. 1B shows a perspective view of the interior of the portable blind spot detector.

FIG. 2 shows a perspective view of magnetic elements disposed on the housing of the portable blind spot detector.

FIG. 3 shows a side elevation view of the portable blind spot detector secured to the side of a tractor trailer.

FIG. 4 shows a top elevation view of the portable blind spot detector secured to the side of a tractor trailer, indicating the areas visible to rear view mirrors and areas detectable by the sensors of the portable blind spot detector.

### DETAILED DESCRIPTION OF THE INVENTION

Reference is made herein to the attached drawings. Like reference numerals are used throughout the drawings to depict like or similar elements of the portable blind spot detector. The figures are intended for representative purposes only and should not be considered to be limiting in any respect.

As used herein, “logic” refers to (i) logic implemented as computer instructions and/or data within one or more computer processes and/or (ii) logic implemented in electronic circuitry. According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

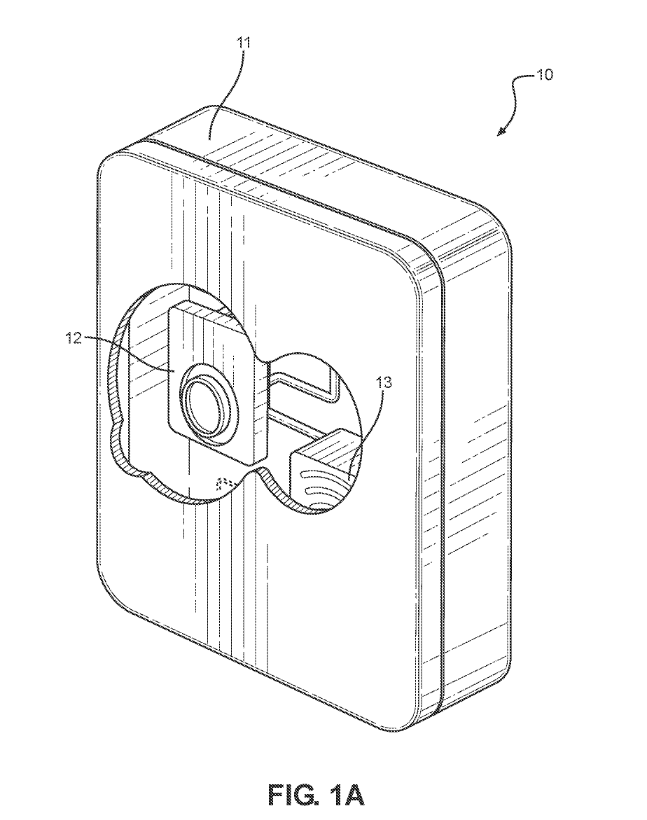

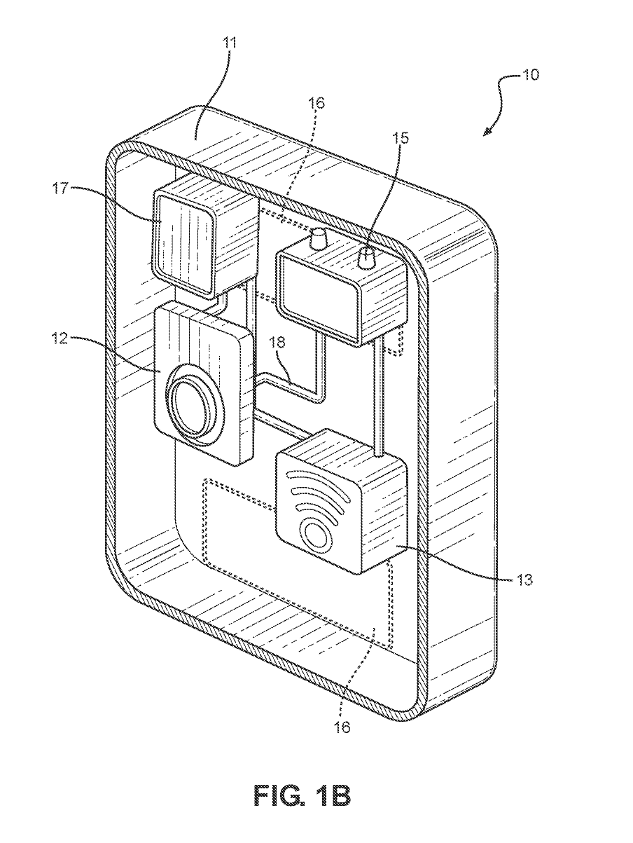

Referring now to FIGS. 1A, 1B and 2, there are shown perspective views of the housing of the portable blind spot detector. The portable blind sport detector 10 comprises a housing having walls 11 and forming an interior. A sensor 12 is disposed within the interior and is operably connected to a wireless transmitter 13 and a power source 15. In some embodiments of the portable blind spot detector 10, there is a logic 17 disposed within the interior and operably connected to the wireless transmitter 13 and the sensor 12.

When the sensor 12 detects that an object has entered a predetermined distance from sensor 12, a signal is sent to the wireless transmitter 13. The wireless transmitter 13 is configured to relay a signal to an alerting unit to indicate to a user that an object has entered the blind spot. In some embodiments of the portable blind spot detector 10, there is a logic 17 disposed within the interior and operably connected to the sensor 12 and the wireless transmitter 13. A signal is sent from the sensor 12 to the logic 17 when an object is detected, wherein the logic 17 relays the signal to the wireless transmitter 13, which then relays the signal to the alerting unit. The logic 17 can also be configured to refrain from alerting the user when certain objects are detected that are unnecessary to signal, such as stationary objects.

In some embodiments of the portable blind spot detector 10, the sensor 12 comprises a motion detector configured to relay a signal when motion is detected within the predetermined area from the sensor 12. In another embodiment, the sensor 12 is a radar sensor, using radio waves to detect surrounding objects. In yet another embodiment, the sensor uses an optical detection method to identify objects that are close by.

The alerting unit is configured to relay an audio or visual signal to a user to indicate that an object has been detected entering the blind spot area. In some embodiments, the alerting unit is a mobile phone and the wireless transmitter 13 uses the Bluetooth standard to relay the signal to the mobile phone. In other embodiments, the wireless transmitter uses an 802.11 wireless communication standard to connect to a mobile phone.

The housing is removably secured to the exterior of a vehicle with fasteners. In some embodiments of the portable blind spot detector 10, the fasteners are magnetic elements 16 disposed on the walls 11 of the housing. For example, strong rare-earth magnets, such as neodymium based magnets, can be used to easily and firmly mount the portable blind spot detector 10 to the side of a truck.

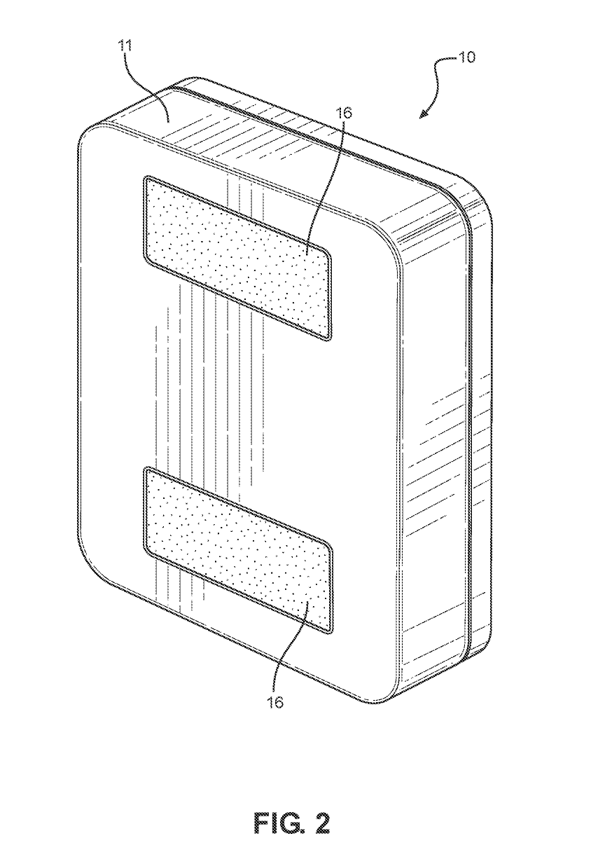

Referring now to FIG. 3, there is shown a side elevation view of the portable blind spot detector secured to the side of a tractor trailer. The portable blind spot detector 10 is removably mountable to the side of a vehicle via the fasteners disposed on the back surface of the housing. This allows a user to quickly remove the housing and place it on another vehicle, as well as easily adjust the positioning of the housing on the vehicle to ensure that the areas detected by the sensor 12 correspond to the blind spot areas of that particular vehicle. While the mirror shape and direction is a significant determiner of blind spots, a driver may wish to adjust the placement of the portable blind spot detector to optimize the detectable area covered based on their personal preference.

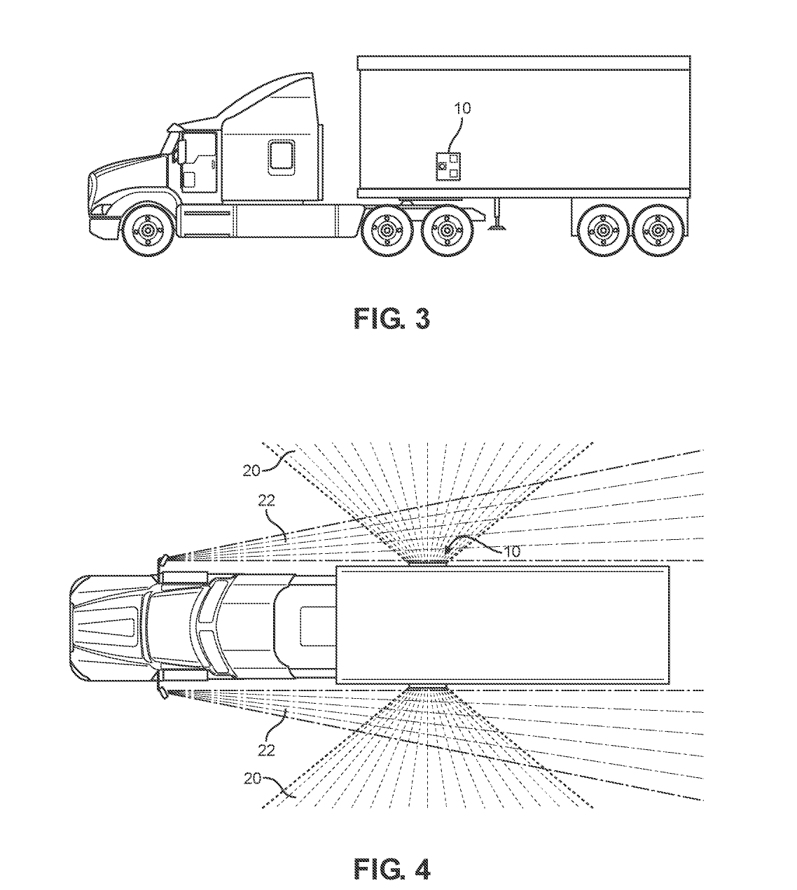

Referring now to FIG. 4, there is shown a top elevation view of the portable blind spot detector secured to the side of a tractor trailer, indicating the areas visible to rear view mirrors and areas detectable by the sensors of the portable blind spot detector. The rear mirrors of a vehicle typically cover a first area 22 running along the length of the vehicle and extending outward. The area outside of that covered by the mirrors are the blind spots. The portable blind spot detector 10 is placeable on the vehicle to detect a second area 20. A driver can adjust the placement of the portably blind spot detector 10 to ensure that the sensor is used efficiently to detect the maximum amount of the area within a blind spot.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable blind spot detector, comprising:
a housing including a fastener, the fastener removably securable to an exterior of a vehicle;
a sensor disposed on the housing, the sensor adapted to detect a distance of separation between the vehicle and an external object;
a logic operably connected to the sensor;
a wireless transmitter operably connected to the logic, wherein said wireless transmitter transmits a signal to an alerting unit when the distance of separation falls below a predetermined minimum distance.

2) The portable blind spot detector of claim 1, further comprising a power source disposed within the housing and operably connected to each of the sensor, the logic, and the wireless transmitter.

3) The portable blind spot detector of claim 1, wherein the wireless transmitter uses a Bluetooth wireless standard to transmit the signal to the alerting unit.

4) The portable blind spot detector of claim 1, wherein the wireless transmitter uses an 802. 11 wireless communication standard to transmit the signal to the alerting unit.

5) The portable blind spot detector of claim 1, wherein the sensor is an optical proximity sensor.

6) The portable blind spot detector of claim 1, wherein the sensor is a radar proximity sensor.

7) The portable blind spot detector of claim 1, wherein the sensor is a motion detector.

8) The portable blind spot detector of claim 1, wherein the fastener is a magnetic element disposed on the walls of the housing.
